(19) United States
(12) Patent Application Publication
(10) Pub. No.: US 2014/0111137 A1
(43) Pub. Date: Apr. 24, 2014

(54) CHARGING APPARATUS

(71) Applicant: K&M CORPORATION, Tokyo (JP)

(72) Inventor: Yoshikiyo TANIKAWA, Tokyo (JP)

(73) Assignee: K&M CORPORATION, Tokyo (JP)

(21) Appl. No.: 14/143,641

(22) Filed: Dec. 30, 2013

Related U.S. Application Data
(63) Continuation of application No. PCT/JP2013/062702, filed on May 1, 2013.

(30) Foreign Application Priority Data
Jul. 25, 2012 (JP) 2012-165254

(51) Int. Cl. H02J 7/00

(52) U.S. Cl. CPC H02J 7/0052
USPC 320/101; 320/162

(57) ABSTRACT

A charging apparatus may include an increase and decrease unit configured to increase and decrease charging current to the storage battery; a detection unit configured to detect a temporal change of a voltage or current supplied from a power generation source to the power conditioner; and a control unit configured to control the increase and decrease unit to increase the charging current over time, to continue increasing the charging current when a temporal amount of decrease of the voltage or current detected by the detection unit is smaller than a predetermined threshold, and to decrease the charging current by a predetermined amount when the temporal amount of decrease of the voltage or the current is equal to or larger than the predetermined threshold.

### CROSS REFERENCE TO RELATED APPLICATIONS

This application is a continuation application under 35 U.S.C. §120 of PCT/JP2013/062702, filed May 1, 2013 which is incorporated herein reference and which claimed priority to Japanese Application No. 2012-165253, filed Jul. 25, 2012. The present application likewise claims priority under 35 U.S.C. §119 to Japanese Application No. 2012-165253, filed Jul. 25, 2012, the entire content of which is also incorporated herein by reference.

### TECHNICAL FIELD

The present invention relates to a charging apparatus.

### BACKGROUND

The power failures in the Great East Japan Earthquake have raised the importance of an emergency power system using a storage battery. Further, an electric storage device in response to a long-term power failure in a large-scale disaster similar to the Great East Japan Earthquake grows increasingly importance. For example, a technique relating to an apparatus capable of being charged directly from a photovoltaic cell has been proposed.

PTL 1 discloses a technique for efficiently charging a storage battery using a photovoltaic cell in a simple configuration by detecting the charging current with a voltmeter to control the switch so as to keep the charging current maximum.

PTL 2 discloses a technique making it possible to charge a storage battery from a photovoltaic cell even while a related system operates by including a charging path from the output side of a power conditioner to a storage battery, separately from a discharging path from the storage battery to the input side of the power conditioner through a discharging diode and a relay.
{PTL 1} JP 07-200963 A
{PTL 2} JP 2008-131759 A

### SUMMARY

By the way, the technique disclosed in PTL 1 does not consider interconnection with a commercial power source system. The technique disclosed in PTL 2 considers interconnection with a commercial power source system. However, it is necessary to add a new circuit. Thus, it is difficult to apply this technique to an existing power conditioner. As a result, there is a problem in that it is difficult to apply these techniques to photovoltaic devices installed in one million homes or more across the country.

On the other hand, a power conditioner in an existing photovoltaic device has a self-sustained operational function. Thus, by using this function, alternating-current power up to about 1.5 kW can be obtained during the day even in a long-term power failure. Thus, it is possible to charge a storage battery using the self-sustained operational function.

However, a power conditioner shuts down in a general photovoltaic device when the load power becomes larger than the power supplied from the photovoltaic cell in a self-sustained operation. When such shut down occurs, the power conditioner is less likely to be recovered unless the power conditioner is manually restarted. For example, when the user tries to charge an electric storage device that needs input power of 1 kW using the self-sustained operation of a photovoltaic device, it is difficult to start charging on a day when the generated power of only 1 kW or less can be obtained, for example, in a cloudy day or on a rainy day. Even when charging can be started on a sunny day, the power conditioner shuts down and charging is stopped as soon as clouds cast a shadow over the photovoltaic cell. Thus, there is a problem in that it is difficult to sufficiently charge a storage battery using an existing photovoltaic device.

In light of the foregoing problems, at least an embodiment of the present invention provides a charging apparatus capable of sufficiently charging a storage battery even in a self-sustained operation of the power conditioner.

To solve the above problem, a charging apparatus capable of charging a storage battery with power supplied from a self-sustained operation socket of a power conditioner having a self-sustained operational function comprises an increase and decrease unit configured to increase and decrease the charging current to the storage battery; a detection unit configured to detect the temporal change of the voltage or current supplied from a power generation source to the power conditioner; and a control unit configured to control the increase and decrease unit to increase the charging current over time, to continue increasing the charging current when the temporal amount of decrease of the voltage or current detected by the detection unit is smaller than a predetermined threshold, and to decrease the charging current by a predetermined amount when the temporal amount of decrease of the voltage or the current is equal to or larger than a predetermined threshold.

Such a configuration can sufficiently charge a storage battery even in a self-sustained operation.

The power generation source may be a photovoltaic cell, and the control unit may regulate charging current supplied from the photovoltaic cell to the storage battery through the power conditioner.

Such a configuration can sufficiently charge a storage battery using a photovoltaic cell even if the photovoltaic cell momentarily changes depending on sunshine condition.

The control unit may cause the increase and decrease unit to continue increasing the charging current when a rate of decrease obtained by dividing the temporal amount of decrease of the voltage by a voltage value or obtained by dividing the temporal amount of decrease of the current by a current value is smaller than a predetermined threshold, and cause the increase and decrease unit to decrease the charging current by a predetermined amount when the rate of decrease is equal to or larger than a predetermined threshold.

Such a configuration can surely prevent the power conditioner from shutting down by referring to the rate of decrease of the voltage or the current.

The detection unit may detect the temporal amount of decrease or the temporal rate of decrease of the voltage or current from the power generation source by inputting the voltage or the current through circuits having two different time constants and compering outputs from the two circuits.

Such a configuration can surely detect the temporal amount of decrease or the temporal rate of decrease of the voltage with a simple circuit configuration.

At least an embodiment of the present invention can provide a charging apparatus capable of sufficiently charging a storage battery even in a self-sustained operation of the power conditioner.

### BRIEF DESCRIPTION OF DRAWINGS

FIG. 1 is a block diagram of an exemplary configuration according to an embodiment of the present invention.

FIG. 2 is a circuit diagram of an exemplary configuration of a ΔV determination circuit illustrated in FIG. 1.

FIG. 3 is a table showing the relationship among the current, the input voltage, the voltage change, and the change rate when the load of a power conditioner is changed.

FIG. 4 is a graph showing the relationship among the current, the input voltage, the voltage change, and the change rate when the load of the power conditioner is changed.

FIG. 5A and FIG. 5B are diagrams for describing the operation in the embodiment of the present invention.

FIG. 6 is a flowchart for describing the operation in the embodiment of the present invention.

### DESCRIPTION OF EMBODIMENTS

At least an embodiment of the present invention will be described.

### (A) Configuration of Embodiment

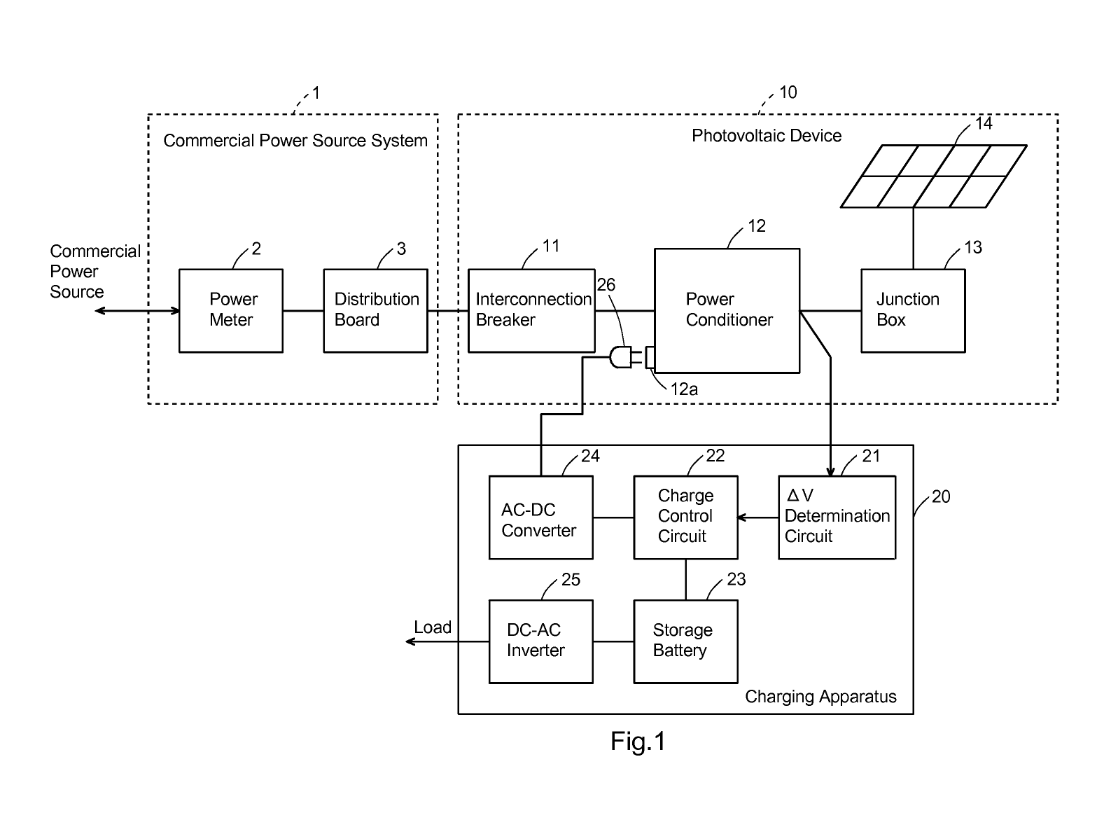

FIG. 1 illustrates an overview of a system that is the combination of a charging apparatus according to an embodiment of the present invention and a photovoltaic device. As illustrated in the drawing, a photovoltaic device 10 generally cooperates with a commercial power source system 1. A charging apparatus 20 according to the embodiment of the present invention is connected to the commercial power source system 1 and the photovoltaic device 10 for use.

The photovoltaic device 10 includes an interconnection breaker 11, a power conditioner 12, a junction box 13, and a photovoltaic cell 14. The charging apparatus 20 includes a ΔV determination circuit 21, a charge control circuit 22, a storage battery 23, an AC-DC converter 24, and a DC-AC inverter 25. The commercial power source system 1 includes a power meter 2 and a distribution board 3.

In that case, the power meter 2 in the commercial power source system 1 measures the amount of electricity supplied from the commercial power source (power purchase) or the amount of electricity supplied from the photovoltaic device 10 to the commercial power source (power sale) to display the amount of electricity. The distribution board 3 distributes the electricity supplied from the commercial power source or the power conditioner 12 to each load and includes circuit breakers that each cut the power when the power consumption at each load exceeds a predetermined value.

The interconnection breaker 11 in the photovoltaic device 10 interconnects the photovoltaic device 10 with the commercial power source system 1 when being on. The interconnection breaker 11 separates the photovoltaic device 10 from the commercial power source system 1 when being off.

The power conditioner 12 converts the direct-current power generated from the photovoltaic cell 14 into alternating-current power having the same voltage (for example, 100V), the same frequency (for example, 50 or 60 Hz), and the same phase as the commercial power source does. The power conditioner 12 generally has a self-sustained operational function for converting the direct-current power generated from the photovoltaic cell 14 into alternating-current power and outputting the alternating-current power from a self-sustained operation socket 12a, independently of the commercial power source. Thus, even though the commercial power source has lost power, the power up to 1.5 kW can be supplied to the load by operating an operation unit (not illustrated in the drawings) in the power conditioner 12 to set the power conditioner 12 at a self-sustained operation mode and connecting the load to the self-sustained operation socket 12a. Note that a power plug 26 from the charging apparatus 20 is connectable to the self-sustained operation socket 12a in the example in FIG. 1.

The junction box 13 integrates the direct-current power generated from the panels on the photovoltaic cell 14 including a plurality of panels in order to supply the power to the power conditioner 12. The photovoltaic cell 14 includes the panels in order to convert sunlight into direct-current power and output the direct-current power.

The ΔV determination circuit 21 in the charging apparatus 20 detects the temporal rate of decrease in the voltage input to the power conditioner 12. When the temporal rate of decrease is equal to or higher than a predetermined threshold, the output signals are set at a high state, or, in other cases, the output signals are set at a low state. The charge control circuit 22 has a function for charging the storage battery 23 with regulating (increasing or decreasing) the charging current flowing from the AC-DC converter 24 to the storage battery 23 based on the output signal from the ΔV determination circuit 21.

The storage battery 23 includes, for example, a lithium-ion battery, a nickel-cadmium battery, a nickel hydride battery, or secondary batteries including a lead battery. The storage battery 23 is charged with the direct-current power supplied from the charge control circuit 22 in order to supply the charged direct-current power to the DC-AC inverter 25.

The AC-DC converter 24 converts the alternating-current power (AC) supplied from the power plug 26 into direct-current power (DC) to output the direct-current power. The DC-AC inverter 25 converts the direct-current power (DC) supplied from the storage battery 23 into alternating-current power (AC) to supply the alternating-current power to the load.

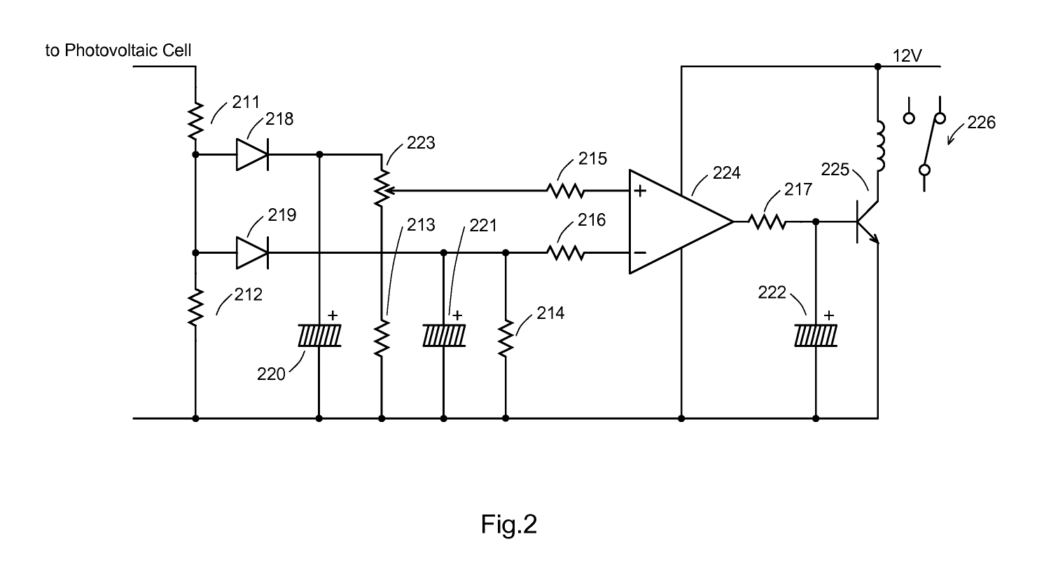

Next, an exemplary configuration of the ΔV determination circuit 21 illustrated in FIG. 1 will be described with reference to FIG. 2. As illustrated in FIG. 2, the ΔV determination circuit 21 includes resistances 211 to 217, diodes 218 and 219, capacitors 220 to 222, a variable resistance 223, a comparator 224, a transistor 225, and an electromagnetic relay 226.

In that case, the resistances 211 and 212 are connected to each other in series and connected to the output from the photovoltaic cell 14. As a result, the resistances 211 and 212 divide the output voltage from the photovoltaic cell 14 according to the element values of the resistances to output the voltage.

The diodes 218 and 219 are for maintaining the voltage. When the voltage of the photovoltaic cell 14 decreases, the diodes 218 and 219 are inversely-biased so as to be in a cut-off state. This maintains the voltages of the capacitors 220 and 221 for a certain length of time.

The capacitor 220 includes, for example, an electrolytic capacitor and is connected to the variable resistance 223 and the resistance 213 in parallel. The capacitor 220 is charged with the output voltage from the photovoltaic cell 14. The capacitor 220 maintains the output voltage from the photovoltaic cell 14 for a certain length of time according to the time constant caused by the capacitor 220, the variable resistance 223, and the resistance 213. More specifically, on the assumption that the variable resistance 223 has an element value VR, the resistance 213 has an element value R1, and the capacitor 220 has an element value C1, the capacitor 220 maintains the voltage for a length of time according to the time constant represented by C1*(VR+R1).

The capacitor 221 includes, for example, an electrolytic capacitor and is connected to the resistance 214 in parallel. The capacitor 221 is charged with the output voltage from the photovoltaic cell 14. The capacitor 221 maintains the output voltage from the photovoltaic cell 14 for a certain length of time according to the time constant caused by the capacitor 221, and the resistance 214. More specifically, on the assumption the resistance 214 has an element value R2, and the capacitor 221 has an element value C2, the capacitor 221 maintains the voltage for a length of time according to the time constant represented by C2*R2. Note that the time constant C1*(VR+R1) caused by the capacitor 220, the variable resistance 223, and the resistance 213 and the time constant C2*R2 caused by the capacitor 221, and the resistance 214 are set so as to have the relationship in which C1*(VR+R1)>>C2*R2 holds. Note that the time constant C1*(VR+R1) is about a few seconds, and the time constant C2*R2 is shorter than the time constant C1*(VR+R1).

The variable resistance 223 includes a variable terminal connected to an input terminal of the comparator 224 through the resistance 215. Operating the variable resistance 223 adjusts the voltage to be input to the comparator 224 such that the voltage ratio at which the comparator 224 is turned on can be set.

The resistances 215 and 216 are the input resistances of the comparator 224 and adjust the current to be input to the comparator 224 such that the current is within a proper range.

The comparator 224 compares the output voltage from the variable resistance 223 to the output voltage from the resistance 214. When the output voltage from the variable resistance 223 is higher than the output voltage from the resistance 214, the comparator 224 sets the output signals at a high state. In other cases, the comparator 224 sets the output signals at a low state.

The resistance 217 and the capacitor 222 are formed into a smoothing circuit to smooth and output the output from the comparator 224. This prevents the occurrence of chattering or the like in the electromagnetic relay 226.

The transistor 225 includes, for example, an NPN bipolar transistor. When the output signal from the comparator 224 is in a high state, the transistor 225 becomes in an ON state so as to allow the electromagnetic relay 226 connected to a collector to conduct the current. When the output signal from the comparator 224 is in a low state, the transistor 225 becomes in an OFF state so as to cut the current to the electromagnetic relay 226.

When the transistor 225 in an ON state allows the coil to conduct the current and switches the junction, the output of the electromagnetic relay 226 becomes in a high state. In other cases, the output of the electromagnetic relay 226 becomes in a low state. The output signal from the electromagnetic relay 226 is supplied to the charge control circuit 22. Note that, although an example in which switching on and off the electromagnetic relay 226 using the output of the comparator 224 outputs signals in a high state and a low state is cited herein, the output signals from the comparator 224 or from the transistor 225 can directly be output without using the electromagnetic relay 226. There is not a specific limitation on how to regulate the charging current with receiving the output from the comparator 224.

### (B) Operation of Embodiment

The operation in the embodiment of the present invention will be described. Note that, hereinafter, both of the operation in normal times and the operation when the commercial power source halts due to a power failure or the like will be described.

The direct-current power generated from the photovoltaic cell 14 is supplied to the power conditioner 12 through the junction box 13 in a normal time when the commercial power source normally operates. The power conditioner 12 converts the direct-current power into alternating-current power having the same voltage, the same frequency, and the same phase as the commercial power source does and then outputs the alternating-current power. The alternating-current power output in such a manner is supplied to the distribution board 3 through the interconnection breaker 11. The alternating-current power supplied to the distribution board 3 is distributed to the loads (for example, home electric appliances) (not illustrated in the drawings) connected to the distribution board 3. When the power supplied from the power conditioner 12 is larger than the power supplied to the loads, the excessive power becomes a reverse power flow (is sold) to the commercial power source. When the power supplied from the power conditioner 12 is smaller than the power supplied to the loads, the deficient power is supplied (is purchased) from the commercial power source through the power meter 2.

The power plug 26 from the charging apparatus 20 is not connected to the self-sustained operation socket 12a in normal times, but is connected to a socket connected to the distribution board 3 such that the storage battery is charged with the power from the commercial power source or the photovoltaic cell 14. Note that, in such a case, the charge control circuit 22 does not perform a process to be described below, but performs a normal charging process. In other words, the charge control circuit 22 controls the charge such that the storage battery 23 is charged with a moderately large current at the beginning of the charge and the current is gradually reduced when the storage battery 23 is nearly fully charged. This can surely charge the storage battery 23 fully in a short time.

Next, the operation when the power supply from the commercial power source halts due to a power failure or the like will be described. In such a case, the user operates the operation unit (not illustrated in the drawings) in the power conditioner 12 to switch the power conditioner 12 to a self-sustained operation mode. This can obtain the power up to about 1.5 kW from the self-sustained operation socket 12a on the power conditioner 12.

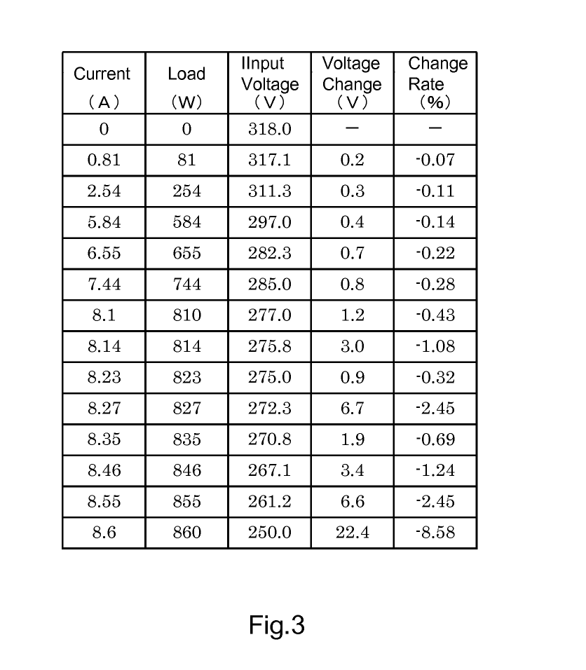

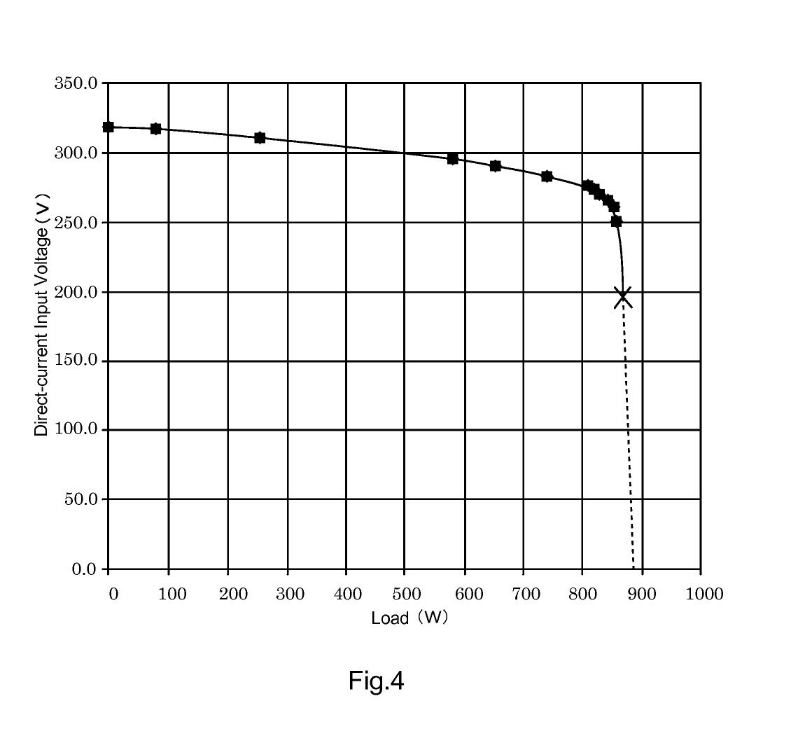

First, the operation of the power conditioner 12 in the self-sustained operation mode will be described. FIG. 3 illustrates an example of the load connected to the self-sustained operation socket 12a, the current flowing through the load, the input voltage to the power conditioner 12, the voltage change per 10 W, and the change rate of the voltage in the self-sustained operation mode. FIG. 4 illustrates the relationship illustrated in FIG. 3 as a graph. As illustrated in the drawings, the increase in the load connected to the self-sustained operation socket 12a gradually reduces the direct-current voltage input to the power conditioner 12 (output voltage from the photovoltaic cell 14) with a slight change rate. The load rapidly changes from a point near the maximum power point (near 850 W in the example illustrated in FIGS. 3 and 4). When the load exceeds the power denoted with an x mark in FIG. 4, the power conditioner 12 shuts down to stop the power supply to the load. When such a state occurs, the user often needs to manually restart the power conditioner 12. Thus, a conventional charging apparatus sometimes remains uncharged when being charged with being connected to the self-sustained operation socket 12a. For example, this is because the power conditioner 12 shuts down during the charge of the storage battery when the electricity generated from the photovoltaic cell 14 decreases due to cloud or the like and is lower than the power consumption of the charging apparatus, and then the power conditioner 12 is not recovered unless a person detects the shutdown.

To solve such a problem, the operation to be described below is performed in the present embodiment. In other words, to charge the storage battery 23 in the self-sustained operation mode, the charge control circuit 22 increases the charging current supplied from the AC-DC converter 24 to the storage battery 23 by a predetermined amount (for example, the current corresponding to 10 W) from 0 A when the power plug 26 from the charging apparatus 20 is connected to the self-sustained operation socket 12a. Then, the charge control circuit 22 refers to the output signal from the ΔV determination circuit 21. When the rate of decrease of the voltage before and after the increase in the load that is to be input to the power conditioner 12 (the value obtained by dividing the amount of decrease of the voltage by the voltage) is less than a predetermined threshold, the same operation is continued. When the rate of decrease is equal to or more than the predetermined threshold (for example, 1% or more), the charging current is set at zero, or is reduced by a predetermined amount (for example, the current corresponding to tens of watts). For example, when the voltage decreases from 270 V to 265 V while the load is increased by 10 W, the rate of decrease of the voltage is 1.85% (=(275−265)/270). The charging current is set at zero, or is reduced by 50 W because the rate of decrease is equal to or more than 1%.

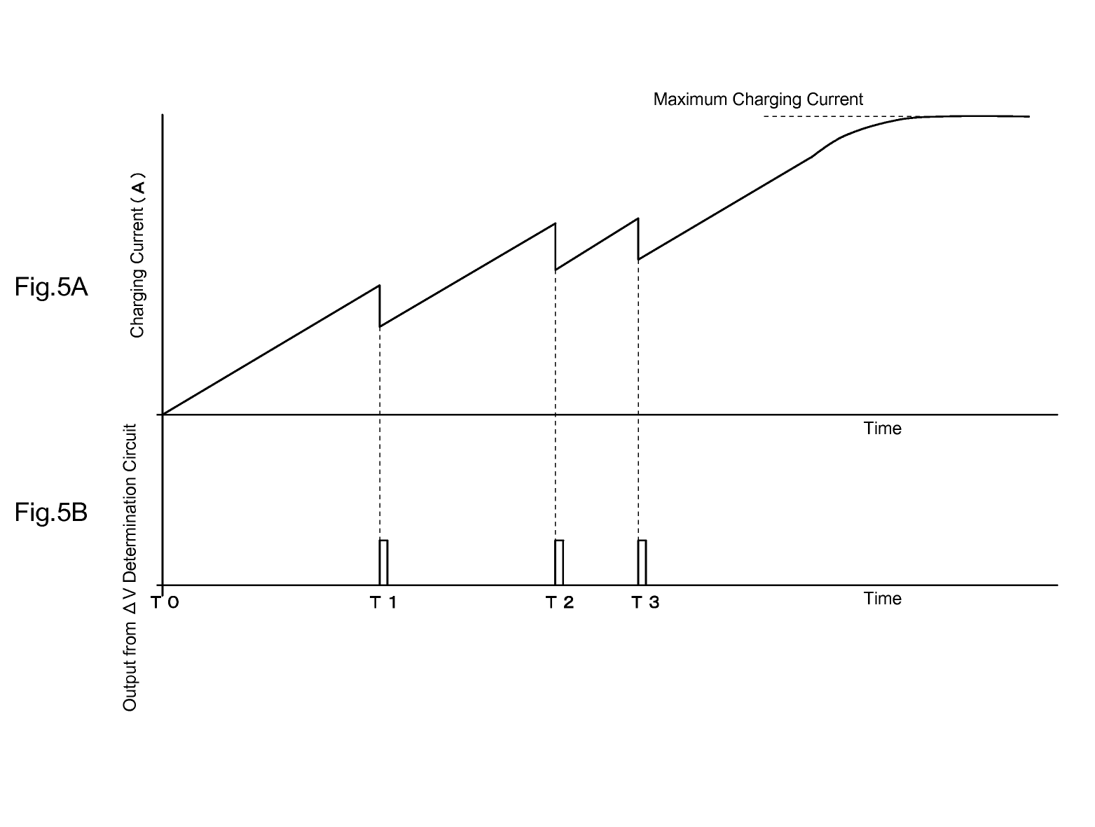

More specifically, after the charge is started at a time T0, the control by the charge control circuit 22 gradually increases the charging current over time as illustrated in FIG. 5A. The increase in the charging current causes the load to gradually increase in FIG. 4. This gradually reduces the direct-current input voltage (output voltage from the photovoltaic cell 14). When the load increases and exceeds around the maximum generated power point (around the apex of an I-V curve (see FIG. 4)) (exceeds 850 W in FIG. 4), the rate of decrease of the voltage with the increase in the load rapidly increases. The ΔV determination circuit 21 calculates the rate of decrease of the voltage from the different time constants (namely, the C1*(VR+R1) and the C2*R2). When the rate of decrease is equal to or more than a predetermined threshold (for example, 1%), the output from the comparator 224 becomes a high state and the junction of the electromagnetic relay 226 is changed. This causes the output from the ΔV determination circuit 21 to become a high state at a time T1 as illustrated in FIG. 5B. As a result, the charge control circuit 22 reduces the charging current by a predetermined (for example, a current corresponding to tens of watts). Thus, the charging current decreases by a predetermined amount as illustrated in FIG. 5A. This can prevent the power conditioner 12 from shutting down because the charging current decreases (the load is reduced) before the load reaches the x mark illustrated in FIG. 4. On the other hand, when the rate of decrease of the voltage is less than the predetermined threshold, the charging current is gradually increased.

Note that the charging current is increased again after being reduced at the time T1 as illustrated in the example in FIG. 5A. The output from the ΔV determination circuit 21 becomes a high state at a time T2 as illustrated in FIG. 5B and the charging current is reduced by a predetermined amount. The attainment of the charging current to a higher level at that time than at the time T1 is an example when the amount of the power generated from the photovoltaic cell 14 increases. Note that an example in which the amount of the generated power has scarcely changed from the time T2 is shown at a time T3. The charging current nearly attains the same level as at the time 2. In the example, the generated power further increases after a time T3. The charging current reaches the maximum charging current because the ΔV determination circuit 21 does not generate a pulse in a high state.

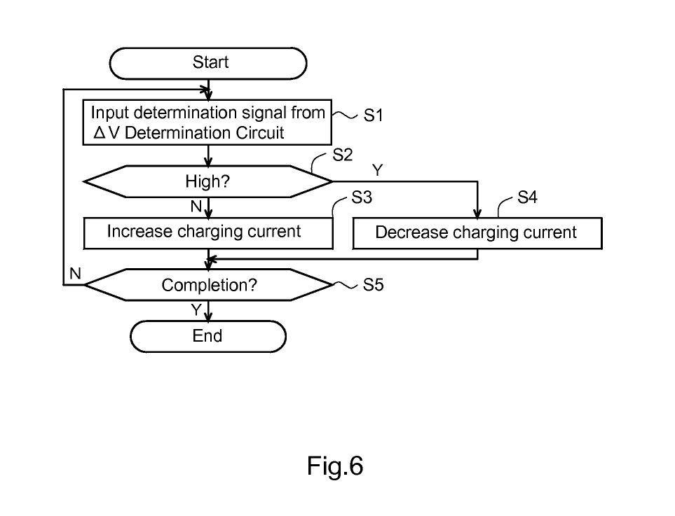

Next, the flow of the procedure performed in the charge control circuit 22 illustrated in FIG. 1 will be described with reference to FIG. 6. After the process of the flowchart illustrated in FIG. 6 is started, the steps to be described blow are performed.

The charge control circuit 22 inputs the output signal from the ΔV determination circuit 21 in step S1. Specifically, the ΔV determination circuit 21 inputs the output from the photovoltaic cell 14 in order to detect the temporal change of the output voltage according to the different two time constants (the C1*(VR+R1) and the C2*R2). At that time, that C1*(VR+R1)>>C2*R2 holds. The time constant C1*(VR+R1) is about a few seconds, and the time constant C2*R2 is shorter than the time constant C1*(VR+R1). For example, the variable resistance 223 outputs the voltage corresponding to the output voltage from the photovoltaic cell 14 before the change of the charging current while the resistance 214 outputs the voltage corresponding to the output voltage of the photovoltaic cell 14 after the change of the charging current. The comparator 224 compares the voltages to cause the output to be a high state when the rate of decrease of the voltage after the change is equal to or higher than a predetermined threshold, or, to cause the output to be a low state in other cases. As a result, the output from the comparator 224 in a high state drives the electromagnetic relay 226. This causes the output from the ΔV determination circuit 21 to be a high state. In other cases, the output from the ΔV determination circuit 21 becomes a low state. The charge control circuit 22 inputs the output signal from the ΔV determination circuit 21.

The charge control circuit 22 determines in step S2 whether the output from the ΔV determination circuit 21 is in a high state. When the output from the ΔV determination circuit 21 is in a high state (Yes in step S2), the process goes to step S4. In other cases (No in step S2), the process goes to step S3. For example, the ΔV determination circuit 21 is in a high state at the times T1, T2, and T3 in FIG. 5B. Thus, the charge control circuit 22 determines Yes and the process goes to step S4. In other cases, the process goes to step S3.

The charge control circuit 22 increases the charging current to the storage battery 23 by a predetermined amount in step S3. For example, the charge control circuit 22 increases the charging current to the storage battery 23 by 10 W. Then, the process goes to step S5.

The charge control circuit 22 reduces the charging current to the storage battery 23 by a predetermined amount in step S4. For example, the charge control circuit 22 reduces the charging current to the storage battery 23 by tens of watts. Alternatively, the charge control circuit 22 reduces the charging current to zero. Then, the process goes to step S5. As a result, the charging current decreases by a predetermined amount at the times T1, T2, and T3 as illustrated in FIG. 5A. Note that, at that time, the amount of decrease of the charging current is set to become larger than the amount of increase in step S3 (for example, the amount of increase is set at 10 W and the amount of decrease is set at tens of watts described above).

The charge control circuit 22 determines in step S5 whether to complete the process. When the charge control circuit 22 determines not to complete the process (No in step S5), the process goes back to step S1 to repeat the same process described above. In other cases (Yes in step S5), the process is completed. Note that, as a method for determining to complete the process, there is a method, for example, in which the process is completed when the voltage of the storage battery 23 reaches a certain voltage value determined depending on the type of the storage battery 23. Note that, a mode in which the storage battery 23 is slowly charged by the amount lost by discharge including self-discharge (generally, referred to as trickle charge) can be started after the completion of the charge.

Performing the above-mentioned processes gradually increases the charging current to the storage battery 23 and decreases the charging current by a predetermined amount when the rate of decrease of the voltage of the photovoltaic cell 14 is equal to or more than a predetermined threshold (for example, the load power is kept less than the power supplied from the photovoltaic cell during the self-sustained operation of the power conditioner 12). This can prevent the power conditioner 12 in the self-sustained operation from shutting down. This can prevent the halt of charge due to the shutdown of the power conditioner 12 without the user realizing. This can further save the user's effort to restart the power conditioner 12. This can further charge the storage battery 23 even when the power generated from the photovoltaic cell 14 is smaller than the input power required for the charging apparatus 20 (for example, the rated input power).

### (C) Variation

It should be understood that the above-mentioned embodiment is an example and the present invention is not limited to the embodiment. For example, the case in which the photovoltaic cell 14 is used as the power generation source is cited as an example in the above-mentioned embodiment. However, for example, wind power generation or hydraulic power generation can alternatively be used.

The circuits having the different time constants and the comparator 224 are used as the ΔV determination circuit 21 in the above-mentioned embodiment. However, such a configuration is an example. Another configuration can be used. For example, A/D conversion converts the output voltage from the photovoltaic cell 14 into digital signals such that the same process can be performed with a digital signal processor (DSP) or a central processing unit (CPU) based on the converted digital data.

As illustrated in FIG. 5B, the charging current is reduced by a predetermined amount every time when the output from the ΔV determination circuit 21 becomes a high state in the above-mentioned embodiment. However, the amount by which the charging current is reduced can be changed depending on the circumstances. For example, when the charging current at the time when the output from the ΔV determination circuit 21 becomes a high state increases over time (for example, when the charging current increases from the time T1 to the times T2 and T3 as illustrated in FIG. 5A), or when the charging current temporally remains roughly constant, the output from the photovoltaic cell 14 increases or remains constant. In such a case, the amount of decrease of the charging current is set at a small amount to reduce the loss of power. On the other hand, when the charging current at the time when the output from the ΔV determination circuit 21 becomes a high state decreases over time, the output from the photovoltaic cell 14 decreases. In such a case, prevention of the shutdown of the power conditioner 12 is given the highest priority and the amount of decrease of the charging current can be set at a large amount.

The operation is controlled according to the magnitude of the rate of decrease of the voltage when the charging current is increased in the above-mentioned embodiment. However, the operation can be controlled, for example, not based on the rate of decrease of the voltage, but based on the amount of decrease of the voltage. The setting of the charging current can be determined not based on the voltage but based on the rate of decrease or the amount of decrease of the current, or based on the rate of decrease or the amount of decrease of power.

1. A charging apparatus capable of charging a storage battery with a power supplied from a self-sustained operation socket of a power conditioner having a self-sustained operational function, the charging apparatus comprising:
an increase and decrease unit configured to increase and decrease charging current to the storage battery;
a detection unit configured to detect a temporal change of a voltage or current supplied from a power generation source to the power conditioner; and
a control unit configured to control the increase and decrease unit to increase the charging current over time, to continue increasing the charging current when a temporal amount of decrease of the voltage or current detected by the detection unit is smaller than a predetermined threshold, and to decrease the charging current by a predetermined amount when the temporal amount of decrease of the voltage or the current is equal to or larger than the predetermined threshold.

2. The charging apparatus according to claim 1,
wherein the power generation source is a photovoltaic cell, and
the control unit regulates charging current supplied from the photovoltaic cell to the storage battery through the power conditioner.

3. The charging apparatus according to claim 1,
wherein the control unit causes the increase and decrease unit to continue increasing the charging current when a rate of decrease obtained by dividing the temporal amount of decrease of the voltage by a voltage value or obtained by dividing the temporal amount of decrease of the current by a current value is smaller than a predetermined threshold, and causes the increase and decrease unit to decrease the charging current by a predetermined amount when the rate of decrease is equal to or larger than a predetermined threshold.

4. The charging apparatus according to claim 1,
wherein the detection unit detects the temporal amount of decrease or the temporal rate of decrease of the voltage or current from the power generation source by inputting the voltage or the current through circuits having two different time constants and compering outputs from the two circuits.
